(19) United States
(12) Patent Application Publication
(10) Pub. No.: US 2014/0182542 A1
(43) Pub. Date: Jul. 3, 2014

(54) Circulating Piston Engine

(71) Applicant: WB Development Company LLC, Marlborough, MA (US)

(72) Inventor: Walter T. Bonin, Marlborough, MA (US)

(73) Assignee: WB Development Company LLC, Marlborough, MA (US)

(21) Appl. No.: 14/145,546

(22) Filed: Dec. 31, 2013

Related U.S. Application Data
(60) Provisional application No. 61/748,558, filed on Jan. 3, 2013.

(51) Int. Cl. F02B 55/02

(52) U.S. Cl. CPC F02B 55/02
USPC 123/242

(57) ABSTRACT

An engine, such as a circulating piston engine, includes a housing that defines an annular bore, a piston assembly, and a valve. The piston assembly is disposed within the annular bore and is configured to be coupled to a drive mechanism. The valve is configured to be intermittently disposed within the annular bore to define a combustion chamber relative to the piston assembly.

### RELATED APPLICATIONS

This patent application claims the benefit of U.S. Provisional Application No. 61/748,558, filed on Jan. 3, 2013, entitled, “Circulating Piston Engine,” the contents and teachings of which are hereby incorporated by reference in their entirety.

### BACKGROUND

Conventional piston engines include multiple cylinder assemblies used to drive a crankshaft. In order to drive the crankshaft, each cylinder assembly requires fuel, such as provided by a fuel pump via a fuel injector. During operation, a spark plug of each cylinder assembly ignites a fuel/air mixture received from the fuel injector and causes the mixture to expand. Expansion of the ignited mixture displaces a piston of the cylinder assembly within a cylinder assembly housing to rotate the crankshaft.

### SUMMARY

By contrast to conventional piston engines, embodiments of the present innovation relate to a circulating piston engine. In one arrangement, the circulating piston engine includes a housing that defines an annular bore extending about its outer periphery and a set of pistons disposed within the bore and secured to a drive mechanism or driveshaft. The engine also includes a set of valves that are moveably disposed within the bore, each valve being configured to define a temporary combustion chamber relative to a corresponding piston.

During operation, when disposed in a first position, each valve defines a combustion chamber relative to a corresponding piston, a fuel injector introduces a gas/air mixture into the chamber, and a spark plug ignites the mixture. Combustion of the mixture generates a corresponding force on each piston (e.g., along a direction that is substantially tangential to the annular bore along the direction of rotation of the drive mechanism) and propels the pistons forward within the annular bore. As each piston advances toward a subsequently disposed valve, each of the valves moves to a second position within the annular bore to allow each piston to rotate past the corresponding valve. Next, the engine repositions each valve within the bore to the first position to define the combustion chamber with the corresponding piston and the process begins again. Accordingly, as the set of pistons rotate around the perimeter of the engine, the drive mechanism generates a relatively large torque, such as an average torque of about 4500 ft-lbs. At ignition, the drive mechanism can generate a torque of about 10,000 ft-lbs. These torques are generated by the relatively large moment arm between each piston and the drive mechanism, as well as the 90° direction of the force applied to each piston.

In one arrangement, the annular bore defined by the engine housing has a relatively large circumference. During operation, when divided by the pistons, this results in a relatively long stroke distance utilizing a high percentage of the energy generated by combustion of the fuel/air mixture within the combustion chamber. Additionally, the substantially continuous motion of the pistons within the annular bore reduces the duration of time that each piston is exposed to the heat of combustion, thereby providing the engine with a relatively high thermal efficiency (e.g., relative to crankshaft-based engines). Also, the configuration of the fuel delivery system of the engine allows the fuel to be delivered to the engine in a process that is separate from, but parallel to, the combustion process. This creates, in effect, a single cycle engine where the combustion process is substantially continuous and where the power output of the engine can be increased (e.g., increased to a horsepower of about 685 @800 RPM) relative to conventional engines. Accordingly, the engine configuration results in the delivery of more precise fuel ratios, a more complete combustion of the fuel/air mixture, and shorter times at high temperatures compared to conventional piston engines. This can reduce the amount of contaminants generated by the engine and output as part of the exhaust and can increase the engine's efficiency such as to an efficiency of about 60%.

In one arrangement, embodiments of the innovation relate to an engine, such as a circulating piston engine. The engine includes a housing that defines an annular bore, a piston assembly, and a valve. The piston assembly is disposed within the annular bore and is configured to be coupled to a drive mechanism. The valve is configured to be intermittently disposed within the annular bore to define a combustion chamber relative to the piston assembly.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates an overhead, cross-sectional, schematic view of an engine having a piston assembly disposed in a first position within the housing, according to one arrangement

FIG. 2A illustrates a partial sectional view of a portion of an annular bore of FIG. 1, according to one arrangement.

FIG. 2B illustrates a partial sectional view of a portion of the annular bore of FIG. 2A, according to one arrangement.

FIG. 3 illustrates an overhead, cross-sectional, schematic view of the engine of FIG. 1 having a piston assembly disposed in a second position within the housing, according to one arrangement.

### DETAILED DESCRIPTION

Embodiments of the present innovation relate to a circulating piston engine. In one arrangement, the circulating piston engine includes a housing that defines an annular bore extending about its outer periphery and a set of pistons disposed within the bore and secured to a drive mechanism or driveshaft. The engine also includes a set of valves that are moveably disposed within the bore, each valve being configured to define a temporary combustion chamber relative to a corresponding piston.

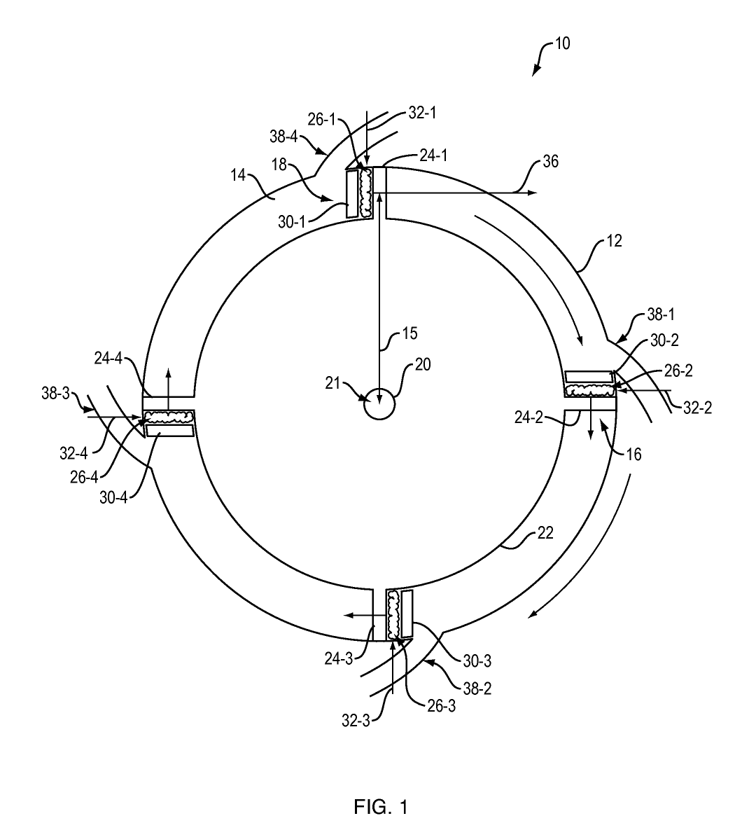

FIG. 1 illustrates an overhead, cross-sectional, schematic view of a circulating piston engine 10, according to one arrangement. The engine 10 includes a housing 12 that defines an annular channel or bore 14 and that contains a piston assembly 16 and a valve assembly 18.

The annular bore 14 is disposed at an outer periphery of the housing 12. While the annular bore 14 can be configured in a variety of sizes, in one arrangement, the annular bore 14 is configured as having a radius 15 of about twelve inches relative to an axis of rotation 21 of the piston assembly 16. As will be described below, with such a configuration, the relatively large radius 15 of the annular bore 14 disposes the engine combustion chamber at a maximal distance from the axis of rotation 21 and allows the piston assembly to generate a relatively large torque on an associated drive mechanism 20, such as a drive shaft, disposed at the axis of rotation.

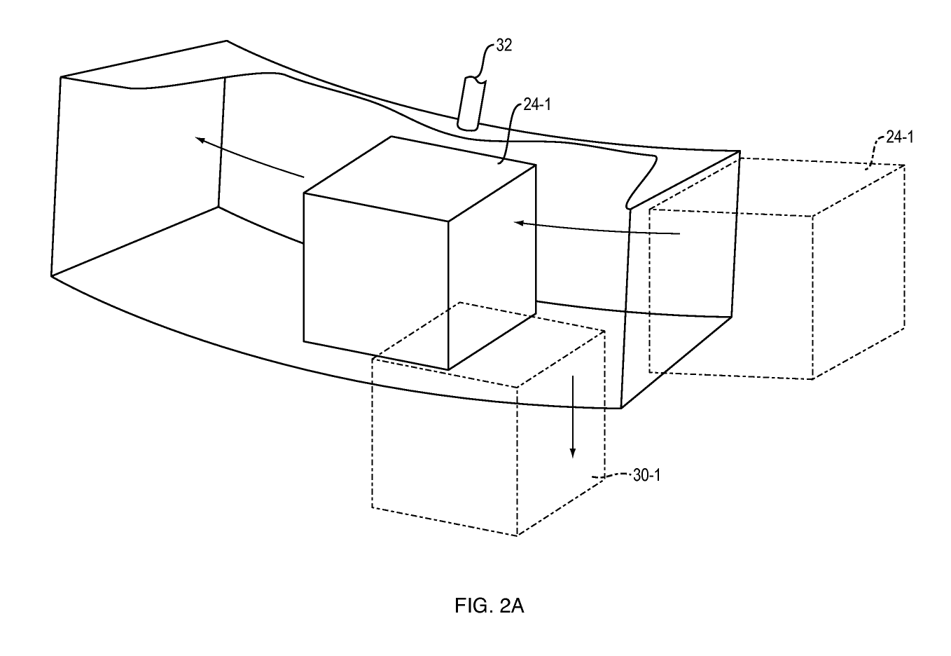

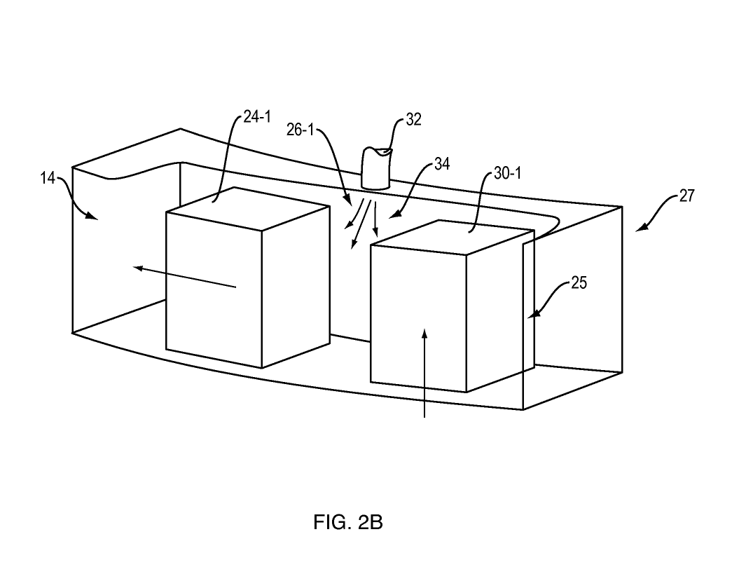

The annular bore 14 can be configured with a cross-sectional area having a variety of shapes. For example, with reference to FIG. 2B, in the case where a piston 24 of the piston assembly 16 is configured to define a generally rectangular cross-sectional area 25, the annular bore 14 can also define a corresponding rectangular cross-sectional area 27. In such an arrangement, the cross-sectional area 27 of the annular bore 14 is larger than the cross sectional area 25 of the piston 24 to allow the piston 24 to travel within the annular bore 14 during operation.

Returning to FIG. 1, in the arrangement illustrated, the piston assembly 16 is disposed within the annular bore 14 and is coupled to the drive mechanism 20 via a flywheel 22. While the piston assembly 16 can include any number of individual pistons 24, in the arrangement illustrated, the piston assembly 16 includes four pistons 24-1 through 24-4 disposed about the periphery of the flywheel 22. While the pistons 24 can be disposed at a variety of locations about the periphery of the flywheel 22, in one arrangement, opposing pistons are disposed at an angular orientation of about 180° relative to each other and adjacent pistons disposed at an angular orientation of about 90° relative to each other. For example, as illustrated, the first and third pistons 24-1, 24-3 are disposed on the flywheel 22 at about 180° relative to each other and the second and fourth pistons 24-2, 24-4 are disposed on the flywheel 22 at about 180° relative to each other. Additionally, the first and second pistons 24-1, 24-2 are disposed on the flywheel 22 at a relative angular orientation of about 90°, the second and third pistons 24-2, 24-3 are disposed on the flywheel 22 at a relative angular orientation of about 90°, the third and fourth pistons 24-3, 24-4 are disposed on the flywheel 22 at a relative angular orientation of about 90°, and the fourth and first pistons 24-4, 24-1 are disposed on the flywheel 22 at a relative angular orientation of about 90°.

During operation, the pistons 24 of the piston assembly 16 are configured to rotate within the annular bore 14. As illustrated, the pistons 24 are configured to rotate within the annular bore 14 in a clockwise direction. However, it should be noted that the pistons can rotate within the annular bore 14 in a counterclockwise manner as well. Such rotation causes rotation of the drive mechanism 20.

The valve assembly 18 includes a set of valves 30 configured to define combustion chambers 26 relative to the respective pistons 24 of the piston assembly 16. For example, while the valve assembly 18 can include any number of individual valves 30, in the arrangement illustrated, the valve assembly 18 includes valves 30-1 through 30-4 disposed within the annular bore 14 of the housing 12. While the valves 30 can be disposed at a variety of locations about the periphery of the housing 12, in one arrangement, opposing valves are disposed at an angular orientation of about 180° relative to each other and adjacent valves disposed at an angular orientation of about 90° relative to each other. For example, as illustrated, the first and third valves 30-1, 30-3 are disposed about the periphery of the housing 12 at about 180° relative to each other and the second and fourth valves 30-2, 30-4 are disposed about the periphery of the housing 12 at about 180° relative to each other. Additionally, the first and second valves 30-1, 30-2 are disposed about the periphery of the housing 12 at a relative angular orientation of about 90°, the second and third valves 30-2, 30-3 are disposed about the periphery of the housing 12 at a relative angular orientation of about 90°, the third and fourth valves 30-3, 30-4 are disposed about the periphery of the housing 12 at a relative angular orientation of about 90°, and the fourth and first valves 30-4, 30-1 are disposed about the periphery of the housing 12 at a relative angular orientation of about 90°. In such an arrangement, the relative positioning of the valves 30 of the valve assembly 18 corresponds to the relative positioning of the pistons 24 of the piston assembly 16.

Each valve 30 of the valve assembly 18 is moveably disposed within the annular bore 14 to create a temporary combustion chamber 26 relative to a corresponding piston 24. For example, during operation, each piston 24 of the piston assembly 16 rotates within the annular bore 14 and toward a valve 30 of the valve assembly 18. Taking piston 24-1 and valve 30-1 as an example, and with reference to FIG. 2A, as the piston 24-1 transitions within the annular bore 14 from a distal position to a proximal position relative to the corresponding valve 30-1, the valve 30-1 is disposed in a first position relative to the annular bore 14. In the first position, the valve 30-1 is at least partially withdrawn from the travel path of the piston 24-1 within the annular bore 14 to allow the piston 24-1 to advance along its travel path. With reference to FIG. 2B, when the piston 24-1 reaches a given location within the annular bore 14 (e.g., once the piston 24-1 has passed the valve 30), the valve 30-1 moves to a second position relative to the annular bore 14 (e.g., to a closed position), such as illustrated. With such positioning, the valve 30-1 defines the combustion chamber 26-1 relative to the piston 24-1 and is configured as a bulkhead against which combustion can work to produce power.

For example, with each valve 30 disposed in a closed position as indicated in FIG. 1, a fuel injector 32 then delivers a fuel-air mixture 34 into the associated combustion chambers 26 which can then be ignited by an ignition device (not shown) such as a spark plug. As the ignition devices ignite the fuel-air mixture 34 in all four of the combustion chambers 26-1 through 26-4 in a substantially simultaneous manner, the expansion of the fuel-air mixture 34 against each valve 30-1 through 30-4 generates a load 36 on each of the corresponding pistons 24-1 through 24-4 to propel each piston 24-1 through 24-4 along the rotational travel path defined by the annular bore 14.

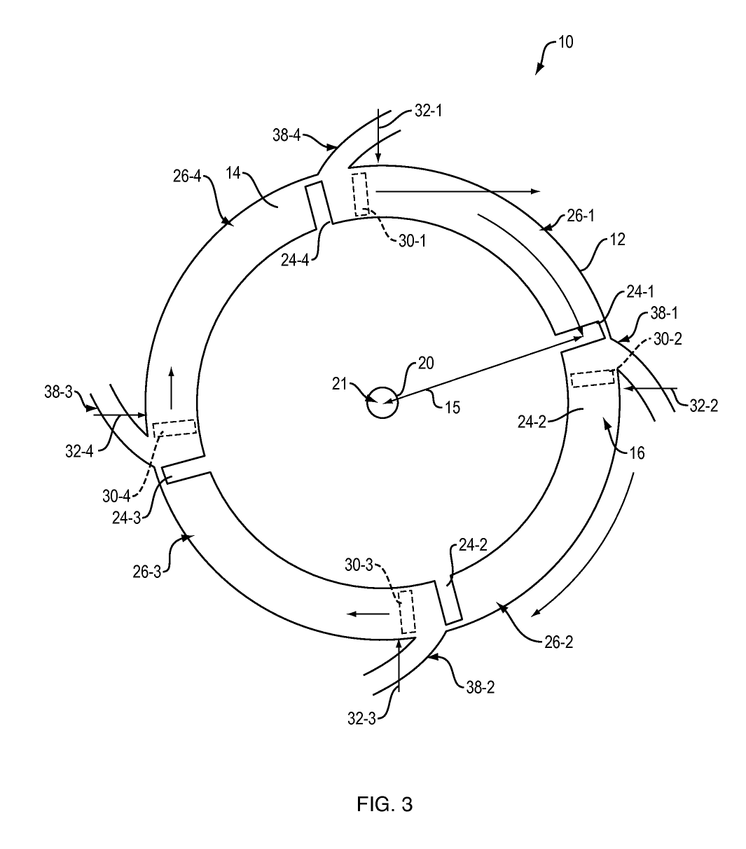

With reference to FIG. 3, each of the pistons 24-1 through 24-4 travels within the bore 14 along a relatively large stroke distance, such as a distance of between about 12 inches and 15 inches, toward the next valve 30. At a certain point in the bore 14, such as at the end of a stroke length 13 as illustrated in FIG. 1, each piston 24 passes a corresponding exhaust port 38 (i.e., disposed proximal to the subsequent valve 30) which vents the spent gas contained in the chamber 26 to the atmosphere. For example, as piston 24-1 passes the exhaust port 38-1, spent gas contained in the chamber 26-1 between the piston 24-1 and the valve 30-1 can exit the chamber 26-1 via the exhaust port 38-1.

The exhaust ports 38, in one arrangement, are configured as passive ports which are open to the atmosphere and which do not require mechanical components. In one arrangement, each exhaust port 38 is configured as being relatively large to provide efficient exhausting to the engine 10. For example, the stroke distance between the piston 24 and valve 30, such as a stroke distance of between about 12 inches and 15 inches, can form part of each exhaust port 38 to increase the overall length of the port 38.

Additionally, as each piston 24 approaches the subsequently disposed valve 30, each valve 30 moves from the second, closed position (FIGS. 1 and 2B) to the first position (FIGS. 3 and 2A) relative to a corresponding piston 24. For example, as the piston 24-1 approaches the valve 30-2, the valve 30-2 is at least partially withdrawn from the bore 14 to allow the piston 24-1 to move past the valve 30-2. Once each of the pistons 24 have translated to a location distal to the corresponding valves 30, the corresponding valves 30 are moved to the first position and the process begins again. Accordingly, during operation, the engine 10 can generate up to sixteen combustion events per revolution (i.e., each of four pistons 24 experiencing up to four combustion events in a single revolution), thereby causing the piston assembly 16 to rotate the drive mechanism 20.

In use, the pistons 24 and valve assembly 16 are disposed at the outer perimeter of the engine housing 12, such as at distance of about twelve inches from the drive mechanism 20. With the combustion force applied to the pistons 24 along a direction that is tangent to the direction of rotation and perpendicular to the distance 15 from the drive mechanism 20, such combustion force can maximize torque on the drive mechanism 20. Additionally, the relatively long stroke path of the pistons 24, the presence of the exhaust ports 38, and the ability of the engine 10 to customize the number of combustion events generated in the bore 14 can enhance the performance of the engine 10. For example, the engine 10 can produce a relatively large amount of continuous power (e.g., a horsepower of about 685 @800 RPM) with a relatively high torque (e.g., an average torque of about 4500 ft-lbs) and efficiency (e.g., an efficiency of about 60%) relative to conventional engines having an efficiency of about 25-30%.

In one arrangement, the operation of the engine 10 can considerably reduce pollutants compared with current engines. For example, the relatively long stroke distance, among other factors, can reduce unburnt hydrocarbons and carbon monoxide contained in the combustion chamber 26. Oxides of nitrogen should also be reduced since the amount formed during combustion is proportional to temperature and dwell times. The rapid and continuous motion of the piston 24 within the bore 14 can reduce their formation, as dwell times will be reduced.

As indicated above, the engine 10 can generate relatively large amounts of torque (e.g., 15 times the torque generated by conventional engines). In conventional piston engines, complex six-speed (and greater) transmissions are needed to multiply the engine's torque for adequate performance, which add to the weight, expense, and complexity to the transmissions. However, because the engine 10 described above generates a relatively higher amount of torque, the engine requires fewer gear ratios than conventional engines and, hence, utilizes a lighter and less expensive transmission.

It should be noted that the relatively high torque generated by the engine 10 can be managed by adjustment of the combustion events (i.e., the firing sequence of the pistons 30 and detonation mechanisms) within the engine 10. For example, each piston 24 can experience four combustions per revolution such that the entire piston assembly 16 experiences a total of sixteen combustions per revolution. In order to control the power and output torque of the engine 10 as necessary, the engine 10 can fire anywhere from one to sixteen times per revolution. For example, the combustion chambers 26 are arranged around the periphery and can be fired independent from each other. This allows firing of a combustion event from one to sixteen times per revolution to adjust the velocity of the pistons 24 within the annular bore and to adjust the power or output torque generated by the engine 10. Such a configuration of the engine 10 contrasts the use of a throttle in conventional engines, which manages flow of air and is relatively less efficient.

While various embodiments of the innovation have been particularly shown and described, it will be understood by those skilled in the art that various changes in form and details may be made therein without departing from the spirit and scope of the innovation as defined by the appended claims.

For example, as described above, the piston assembly includes four pistons and the valve assembly includes four valves. Such description is by way of example only. In one arrangement, the piston assembly can include a first piston and a second piston, the first piston disposed within the annular bore at a position that is substantially 180° from the second piston. Additionally, the valve assembly can include a first valve disposed at a first location within the housing and a second valve disposed at a second location within the housing, the second valve being disposed along the annular bore at a position that is substantially 180° relative to the first valve.

As indicated above, each valve 30 of the valve assembly 18 is moveably disposed within an annular bore to create a temporary combustion chamber 26 relative to a corresponding piston 24. For example, with reference to FIG. 2B, when the piston 24-1 reaches a given location within the annular bore 14, the valve 30-1 moves to a second position relative to the annular bore 14. With such positioning, the valve 30-1 forms the combustion chamber 26-1 relative to the piston 24-1 and is configured as a bulkhead against which combustion can work to produce power. In one arrangement, the size of the combustion chamber 26 can be altered during operation to adjust the power output or efficiency of the engine. For example, the volume of the combustion chamber 26 can be decreased or increased by varying the duration of the fuel input process to the combustion chamber 26 and by adjusting (e.g., delaying) the ignition timing accordingly. In the case where the volume of the combustion chamber 26 is increased, the engine can include a second spark plug (not shown) located adjacent to the relatively larger combustion chamber 26 to accelerate combustion in the enlarged chamber.

It should be noted that the walls of the combustion chamber 26 and the direction of introduction of fuel relative to the valve can be modified to create a variety of geometric travel paths for the air/fuel mixture. For example, the walls of the combustion chamber 26 and the direction of fuel introduction can define a circular or other geometry to accelerate ignition and combustion effectiveness.

As indicated above, in order to control the power and output torque of the engine 10 as necessary, the engine 10 can fire anywhere from one to sixteen times per revolution. In one arrangement, the engine 10 can be configured to alternate the firing order of the combustion chambers 26 to reduce the operating temperature of the engine 10. For example, with reference to FIG. 1, in the case where the engine 10 has accelerated to a particular drive mechanism 20 velocity, the engine 10 can require firing of only two combustion chambers 26 during a revolution of the piston assembly 30 within the engine 10 to maintain the velocity. To minimize the engine temperature, in a first revolution cycle, the first 26-1 and third 26-3 combustion chambers can be fired while in a second revolution cycle, the second 26-2 and fourth 26-4 combustion chambers can be fired. When certain combustion chambers 26 are not fired, relatively low temperature air flows through those combustion chambers as well through the annular bore 12, thereby reducing the operating temperature of the engine 10. This allows a leaner fuel-air mixture to be utilized during operation to improve engine efficiency and air quality.

What is claimed is:

1. An engine, comprising:
a housing defining an annular bore;
a piston assembly disposed within the annular bore, the piston assembly configured to be coupled to a drive mechanism; and
a valve moveably disposed within the annular bore to selectively define a combustion chamber relative to the piston assembly.

2. The engine of claim 1, wherein the piston assembly comprises:
a flywheel configured to rotate within the housing about an axis of rotation; and
at least one piston coupled to the flywheel and disposed within the annular bore defined by the housing.

3. The engine of claim 2, wherein the annular bore is disposed at an outer periphery of the housing and defines a radius of about twelve inches relative to the axis of rotation of the flywheel.

4. The engine of claim 2, wherein the at least one piston comprises a first piston and a second piston, the first piston coupled to the flywheel at a position that is substantially 180° from the second piston.

5. The engine of claim 2, wherein the at least one piston comprises a first piston, a second piston, a third piston, and a fourth piston, each of the first piston, the second piston, the third piston, and the fourth piston coupled to the flywheel such that each piston is disposed on the flywheel at substantially 90° relative to an adjacent piston.

6. The engine of claim 1, wherein the valve is configured to be disposed within the annular bore between (i) a first position that allows a piston of the piston assembly to travel within the annular bore from a location that is distal to the valve to a location that is proximal to the valve and (ii) a second position to define the combustion chamber with the proximally-located piston of the piston assembly.

7. The engine of claim 1, wherein the valve comprises a first valve disposed at a first location within the housing and a second valve disposed at a second location within the housing, the second valve being located consecutively within the annular bore at a position that is substantially 180° relative to the first valve.

8. The engine of claim 1, wherein the valve comprises a first valve disposed at a first location within the annular bore, a second valve disposed at a second location within the annular bore, a third valve disposed at a third location within the annular bore, and a fourth valve disposed at a fourth location within the annular bore, each of the first valve, second valve, third valve, and fourth valve being located consecutively within the annular bore at a position that is substantially 90° relative to a previous valve.

9. The engine of claim 8, wherein the annular bore defines a stroke distance between consecutively located valves, the stroke distance being between about 12 inches and 15 inches.

9. The engine of claim 1, further comprising a fuel injector configured to deliver a fuel-air mixture to the combustion chamber defined between the piston assembly and the valve.

10. The engine of claim 1, comprising an exhaust port disposed in fluid communication with the annular bore, the exhaust port disposed at a location substantially proximal to the valve.

11. The engine of claim 10, wherein the exhaust port is configured as a passive exhaust port.

12. An engine, comprising:
a housing defining an annular bore;
a piston assembly disposed within the annular bore, the piston assembly comprising:
a flywheel configured to rotate within the housing about an axis of rotation, and
a first piston, a second piston, a third piston, and a fourth piston, each of the first piston, the second piston, the third piston, and the fourth piston coupled to the flywheel such that each piston is disposed on the flywheel at substantially 90° relative to an adjacent piston; and
a valve assembly comprising:
a first valve disposed at a first location within the annular bore, a second valve disposed at a second location within the annular bore, a third valve disposed at a third location within the annular bore, and a fourth valve disposed at a fourth location within the annular bore,
each of the first valve, second valve, third valve, and fourth valve located consecutively within the annular bore at a position that is substantially 90° relative to an adjacend valve, and
each of the first valve, second valve, third valve, and fourth valve configured to be disposed within the annular bore between (i) a first position that allows each piston of the piston assembly to travel within the annular bore from a location that is distal to each valve to a location that is proximal to each valve and (ii) a second position to define the combustion chamber with the proximally-located piston of the piston assembly.

13. The engine of claim 12, wherein the annular bore is disposed at an outer periphery of the housing and defines a radius of about twelve inches relative to the axis of rotation of the flywheel.

14. The engine of claim 12, wherein the annular bore defines a stroke distance between consecutively located valves, the stroke distance being between about 12 inches and 15 inches.

15. The engine of claim 12, further comprising a fuel injector configured to deliver a fuel-air mixture to the combustion chamber defined between the piston assembly and the valve.

16. The engine of claim 12, comprising an exhaust port disposed in fluid communication with the annular bore, the exhaust port disposed at a location substantially proximal to the valve.

17. The engine of claim 16, wherein the exhaust port is configured as a passive exhaust port.
